(19) United States
(12) Patent Application Publication
(10) Pub. No.: US 2005/0123456 A1
(43) Pub. Date: Jun. 9, 2005

(54) Device and method for processing biological or chemical substances or substance mixtures thereof

(76) Inventor: Lutz Eichacker, Adlbergweg (DE)

Correspondence Address: RANKIN, HILL, PORTER & CLARK LLP, 4080 ERIE STREET, WILLOUGHBY, OH, 44094-7836, US

(21) Appl. No.: 10/497,895

(22) PCT Filed: Dec. 4, 2002
(86) PCT No.: PCT/EP02/13739

(30) Foreign Application Priority Data
Dec. 4, 2001 (DE) 101-59-198.5
Feb. 22, 2002 (DE) 102-07-648.0

(51) Int. Cl. B01J 19/00

(52) U.S. Cl. 422/130; 422/99

(57) ABSTRACT

A reaction device for processing biological material and especially for processing material containing polypeptides and/or polynucleotides. The reaction device includes a first reaction chamber (50) and a second reaction chamber (51) that are connected via a first transition region (5). The first transition region also includes a narrowing cross-section. The cover of the reaction vessel is in the form of a reaction chamber. The biological materials introduced into the reaction chamber are displaced by the effect of a force, especially by gravitation, between the reaction chambers of the reaction device.

Processing biological materials in a biochemical laboratory is preferably done in reactor vessels. Generally, such reactor vessels comprise a reaction space provided with an opening for introducing biological and/or chemical substances therein. The cover of the reaction space usually involves a lid configured separate from or joined to the reaction vessel.

When processing biological materials in such reactor vessels usually only single steps in the reaction are implemented in one and the same reaction vessel so that, for example, the reaction vessel needs to be charged with the reaction educts before implementing the reaction and the reaction products removed from the reaction vessel after the reaction, the reaction vessel then being discarded.

One possibility applicable to a restricted degree of implementing several reactions in sequence in one and the same reaction vessel exists when the reaction product can be used unchanged as the reaction educt for each subsequent reaction. It can then remain in the reaction vessel and following the addition of further reaction educts the subsequent reaction can be implemented in the same reaction vessel.

A disadvantage in this arrangement is the risk of contamination in multiply opening and charging the reaction vessel with subsequent reaction educts or when removing the reaction products from the reactor vessels for implementing further reactions. In view of the nowadays achievable high sensitivity of biological or biochemical techniques such a contamination may seriously falsify the findings, rendering them useless.

Another disadvantage in implementing biological or biochemical reactions with known reactor vessels are the complications involved in the lab from the many steps in processing between the individual reactions and due to processing biological materials usually involving a lot of time, labor and costs and thus proving inefficient.

Thus, it is an object of the present invention to provide a reaction device or reaction module as well as a method as an improvement over prior art and which leads to an increased accuracy and efficiency in implementing biological or biochemical reactions.

To achieve this object the invention provides a reaction device comprising at least two reaction spaces interconnected by at least one transition zone having a narrowing cross-section. In this arrangement the reaction device in accordance with the invention may be configured, for example, as a vessel comprising two separate reaction spaces interconnected by a first transition zone. Preferably the first transition zone comprises at least one defining element oriented inclined to the longitudinal centerline of the reaction device, it being particularly preferred when the transition zone comprises a funnel-shaped defining element oriented substantially cylindrical symmetrical to the longitudinal centerline of the reaction device and arranged substantially centrally within the reaction device.

In another embodiment the transition zone comprises a defining element oriented inclined relative to the wall of the reaction device so that the transition zone likewise features a narrowing or tapered cross-section which, however, is not oriented symmetrical to the longitudinal centerline of the reaction device, it instead being disposed between the defining element and the wall of the reaction device and thus substantially eccentrically.

In a preferred embodiment the tapered cross-section of the transition zone changes into a capillary of minimum cross-section, preferably smaller than 1 μm, preferably smaller than 5 μm, preferably smaller than 10 μm, preferably smaller than 20 μm, preferably smaller than 50 μm, preferably smaller than 100 μm, preferably smaller than 200 μm, preferably smaller than 500 μm, preferably smaller than 1 mm.

The transition zone interconnects the reaction spaces of the reaction device for a material or substance communication, the cross-section being selected so that, by virtue of its consistency, such as for example molecular size, viscosity, surface tension or the like, the biological, biochemical and/or chemical material introduced into the first reaction space is substantially prevented from passing through the transition zone into the second reaction space.

A transition zone in the sense of the present invention is a zone through which a biological, biochemical or chemical material is transported by an exogenic influence or by a change in the material properties of the material such as a change in the surface tension, material size, viscosity or the like in thereby interacting with other components, for example portions of the transition zone and/or resulting in a change of state, for example, by breaking up a matrix structure of the material.

In a particularly preferred embodiment of the present invention the reaction device is configured so that materials or substances introduced into the first reaction space of the reaction device can be transported prior to or after conclusion of the desired reaction through the first transition zone into the second reaction space. For this purpose, either the consistency of the materials needs to be altered such that they can pass through the first transition zone into the second reaction space or, instead, a force, preferably gravitational force, more particularly centrifugal force, electrical and/or magnetic force needs to be applied to the materials. Particularly preferred, the materials are transported from the first reaction space into the second reaction space by arranging the reaction device in a centrifuge to thus exert a gravitational force in passing the materials through the first transition zone.

In this way, it is possible to implement two or more reactions, depending on the configuration of the device in accordance with the invention, in different reaction spaces of one and the same reaction device without the reactions products or reaction educts needing to be removed from or introduced into the reaction device between the individual reactions.

By exerting a force of given intensity or nature to the materials or substances in the reaction spaces it is now possible to move them specifically between the various reaction spaces.

To generate centrifugal forces or gravitational forces the reaction device may be arranged, for example, in the rotor of a lab centrifuge. By specifying the speed at which the centrifuge is rotated the gravitational force acting on the materials or substances contained therein can be optionally varied.

As a result of this, it is achieved in a further embodiment of the present invention featuring several transition zones arranged one above the other that with a first defined centrifugal speed or gravitational force applied to the substances a transition occurs of the materials or substances introduced into the first reaction space merely into the second reaction space, this being achieved, for example, by suitably selecting the material parameters such as, for example, viscosity, molecular size, specific weight and/or surface tension, on the one hand, and, on the other, the gravitational force.

Then, at a second rotational speed, differing from the first rotational speed the transition of the materials from the second reaction space via a second transition zone into a third reaction space is implemented. In this way, any number of biological or biochemical reactions can now be implemented in sequence in one and the same reaction vessel, simply by varying the force acting on the substances contained in the reaction device.

Apart from the gravitational force any other kind of force can be applied to the contained substances or materials, such as, for example, application of a pressure or vacuum.

In yet another particularly preferred embodiment the defining element comprises at least one through-passage arranged, for example, edgewise at the defining element and which, as viewed by the second reaction space likewise comprises a tapered cross-section. In this arrangement, the through-passage of the defining element may be arranged symmetrical, especially annular or as a circular segment, or also asymmetrically, for example on only one side of the reaction device relative to the longitudinal centerline of the reaction device. Such a through-passage makes it possible to transport the biological or biochemical substances transported from the first reaction space into the second reaction space, for example by centrifugation, as caused to react in the second reaction space by reorientation of the forces acting in the second reaction space, for example, by reorientation of the reaction device in the centrifuge through the through-passage back into the the first reaction space.

In still another particularly preferred embodiment the through-passage of the defining element is provided also by a criss-cross structured element and/or an element comprising porous through-passages having a predefined pore size. Such criss-cross structured elements or elements having porous through-passages may be, for example, molecular sieves or filter elements.

In this way, in returning the substances from the second reaction space into the first reaction space separation of undesirable reaction products or substances having existed or resulting in the reaction in the second reaction space can simultaneously take place. Particularly preferred in returning substances from the second reaction space into the first reaction space is filtering off polymers and/or proteins, such proteins being preferably enzymes having a molecular weight exceeding a critical limit. More particularly such a molecular sieve permits the passage of molecules having a molecular weight of less than 500 kDa, preferably less than 200 kDa, preferably less than 100 kDa, preferably less than 50 kDa, preferably less than 20 kDa, preferably less than 10 kDa, preferably less than 5 kDa, preferably less than 2 kDa, preferably less than 1 kDa.

In yet another particularly preferred embodiment of the present invention the second reaction space of the reaction device is totally closed off from the environment, for example, by a bottom surface or some other element.

In this arrangement, at least the second reaction space of one preferred embodiment of the reaction device in accordance with the invention is charged with a physically, biologically and/or chemically active substance or such a substance being activatable by exogenic influencing actions, it being particularly preferred to arrange the physically, biologically and/or chemically active or activatable substance in at least one portion of the second reaction space. Such active or activatable substances are, for example, enzymatic active substances, preferably proteases, nucleases or the like. These substances may be rendered inactive, for example, by freezing or freeze drying and activated by being brought into contact with a substance, e.g. a fluid, although any other form of enzymatic activity is also just as conceivable.

In yet another embodiment the by physically, biologically and/or chemically active or activatable substances or materials are activated by an exogenic influencing action, more particularly an initially weak physically, biologically and/or chemically active material being activatable by an exogenic influencing action, such as for example by the application of thermal energy, light energy, electrical or magnetic field energy, kinetic energy or the like.

In still another embodiment the physically, biologically and/or chemically activatable material comprises particles of a magnetic material energized, for example, by the application of an external rotating magnetic field to produce motion within the second, or some other, reaction space, resulting in blending of the substances in the second reaction space.

In another particularly preferred embodiment there is provided in at least one of the reaction spaces a sealing element preventing, at least in part, passage of materials or substances through at least one transition zone or at least one through-passage.

Preferably, the sealing element is made of an elastic or inelastic material, particularly a plastics material. The sealing element acts, for example, like a ball valve together with the transition zone or through-passage with the application of a gravitational force on the reaction device and the materials or substances contained therein.

In still another particularly preferred embodiment of the present invention the bottom surface of the reaction device, and particularly of the second reaction space, is covered, at least in part, by an enzymatic active material.

The reaction device in accordance with the invention has a cross-section which, at least in part, is preferably polygonal, more particularly rectangular, square, trigonal, pentagonal or hexagonal. In one particularly preferred aspect the reaction device in accordance with the invention has a cross-section which, at least in part, is circular or elliptical. More particularly, in this arrangement the reaction device in accordance with the invention is configured, at least in part, hollow cylindrical, whereby the cylindrical walls may be configured differently thick and where necessary, provided with additional elements such as retaining elements, closure elements or the like.

In another particularly preferred embodiment of the present invention the reaction device has a free cross-section connecting a third reaction space to the first reaction space or second reaction space. Preferably the free cross-section is defined by the walls of the reaction device in thereby comprising likewise a polygonal or circular or elliptical cross-section, at least in part.

The defining walls of the free cross-section in this arrangement are bevelled, at least in part, on at least one side in the region of the free cross-section. The bevelled walls of the reaction devices may be used, for example, to part portions of polymer matrix arrangements such as, for example, electrophoresis gels, more particularly in isolating, decanting or parting them.

In yet another particularly preferred embodiment the reaction device comprises a cover element releasably connected to the vessel-type underpart of the reaction device so that it covers the free cross-section of the first reaction space, at least in part. Preferably the cover element has a cross-section substantially corresponding to the cross-section of the underpart of the reaction device so that the cover element can be placed on the underpart of the reaction device to close it off.

The walls of the cover element in this arrangement are preferably configured for connection to the walls in the region of the free cross-section substantially positively or for insertion therein or clasping thereof.

Preferably the walls of the cover element, just like the walls of the reaction device are bevelled, at least in part, it being particularly preferred to configure the walls so that a piece of a highly viscous material, such as, for example, a polymer matrix, especially an electrophoresis gel disposed between the reaction element and cover element is either sheared off or parted simply by bringing the cover element and underpart of the reaction device together.

At least in a portion of the cover element at least one absorbent and/or adsorbent is arranged serving, on the one hand, to absorb fluids, on the other, to adsorb biological or biochemical materials, particularly amino acids, amino acid sequences, nucleotides or nucleotide sequences. It is particularly preferred to make a portion of the cover element of one such absorbent and/or adsorbent.

The absorbent or adsorbent comprises, for example, materials selected from a group containing fleece, cellulose, superabsorbers, carbon compounds, hydrocarbon compounds, porous materials, minerals, salts as well as any combination thereof, and the like.

In yet another particularly preferred embodiment of the present invention the cover element is releasably connected to the reaction device, the cover element being connected, for example, by a hinge or a film-type hinge to the reaction device. Particularly preferred, the cover element closes off the reaction device totally in the closed state in the region of the free cross-section, the cover element being removable or separable from the underpart of the reaction device following implementation of the reactions in the reaction device, so that the first reaction space is open to the environment via the free cross-section.

In the closed state of the reaction device it is particularly preferred that the cover element is maintained on the underpart of the reaction device by a locking element preferably arranged at the outer portion of the walls of the reaction device or of the cover element. Such a locking element prevents release of the cover element from the underpart in centrifuge with accelerations up to 100 G, preferably 200 G, preferably 500 G, preferably 1000 G, preferably 2000 G, preferably 5000 G, preferably material 10,000 G, preferably 20,000 G. Securing the cover element to the reaction device may also be done by a positive connection and/or non-positive connection, the cover element being inserted into the underpart of the reaction device and the non-positive connection being intensified in position by centrifugation.

In still another particularly preferred embodiment of the present invention a concentration element is disposed between the underpart of the reaction device and the cover element so that a fourth reaction space is formed between the cover element and concentration element. The cross-section of the concentration element corresponds, at least in part, to the cross-section of the underpart of the reaction device and/or of the cover element, the walls of the concentration element being configured for positive connection and/or non-positive connection with the walls of the underpart and/or with the walls of the cover element. In this arrangement, the walls of the concentration element are in turn configured for shear separation of a highly viscous material, more particularly a polymer matrix or preferably of a electrophoresis gel between the walls of the concentration element and the walls of the underpart of the reaction device.

In yet a further embodiment, the concentration element is connected to the underpart and cover element, for example, by a hinge or a film-type articulation.

In this arrangement the concentration element is to be attached to the reaction device so that the third reaction space is connected to the first reaction space of the reaction device via the free cross-section. The cover element and/or the concentration element is maintained on the underpart of the reaction device preferably by a releasable locking means such that the elements, i.e. the underpart, the cover element and/or the concentration element are not separated from each other even in high acceleration centrifuging. The connection of the elements in a further embodiment of the present invention may also be by positive connection and/or non-positive connection.

It is particularly preferred that the elements form, when interconnected, a substantially closed reaction vessel within which the reaction spaces are rigidly interconnected by transition zones, free cross-sections and/or through-passages.

The concentration element comprises at least one second transition zone preferably having a likewise tapered cross-section defined by at least one second defining element oriented inclined at least in part, relative to the longitudinal centerline of the reaction device.

Particularly preferred, the second transition zone is funnel-shaped at least to one side. Particularly preferred, the second transition zone is arranged substantially concentrically in the concentration element so that the second defining element is configured substantially symmetrical to the longitudinal centerline of the reaction device. In a further embodiment the second transition zone is arranged substantially eccentrically in the concentration element so that, for example, the wall of the concentration element serves, at least in part, as the defining element for the second transition zone. The minimum cross-section of the second transition zone is preferably smaller than 500 nm, preferably smaller than 1 μm, preferably smaller than 5 μm, preferably smaller than 10 μm, preferably smaller than 20 μm, preferably smaller than 50 μm, preferably smaller than 100 μm, preferably smaller than 200 μm, preferably smaller than 500 μm, preferably smaller than 1 mm.

Connecting the cover element to the concentration element forms between the cover element and concentration element the fourth reaction space which is connected to the third reaction space by the second transition zone so that a biological and/or chemical material, more particularly a fluid, a solution or suspension can be transported by force through the transition zone into the fourth reaction space.

In a particularly preferred embodiment of the present invention there is arranged at least in a portion of the second transition zone a second absorbent and/or adsorbent selected from a group containing fleece, cellulose, superabsorbers, carbon compounds, hydrocarbon compounds, column chromatographic adsorbents, porous materials, minerals, salts and the like as well as any combination thereof.

Particularly preferred the zone between the underpart and the concentration element or the underpart and the cover element is configured as a connecting zone which, for one thing, connects the walls of the individual elements positively and/or non-positively, at least in part, and, for another, as a shear or separating zone, in other words as a zone in which part of a material carrying the biological and/or chemical materials or substances is dissociated from the carrier material as a whole, more particularly from a polymer matrix such as for example, a electrophoresis gel or a highly effective carrier material.

In another preferred aspect of the present invention several reaction devices are combined into a reaction module. In this arrangement preferably several underparts of reaction devices are integrated together and made, for example, of Teflon or a thermoplastic or thermosetting material, especially, polypropylene, polyethylene or some other biocompatible material. The reaction devices in this arrangement may be arranged as a kind of honeycomb structure or two-dimensional matrix, the reaction devices preferably comprising a substantially hexagonal cross-section or a substantially square cross-section.

In another embodiment the underparts of the reaction devices are configured in the form of a multi-well plate, in other words as circular wells within a carrier element.

Like the underparts of the reaction devices in such embodiments the concentration elements or cover elements too are grouped together into modules corresponding to the arrangement of the underparts of the reaction devices, comprising a plurality of concentration elements or cover elements for positive and/or non-positive connection to the module comprising the underparts of the reaction devices.

This now makes it possible to process a plurality of biological materials simultaneously or in parallel.

In a particularly preferred embodiment of the present invention the reaction modules are configured such that between the module comprising the underparts of the reaction devices and the module comprising the concentration elements a polymer matrix carrying the biological materials to be analyzed, more particularly an electrophoresis gel can be inserted which, when the modules are joined together, results in the polymer matrix being segmented by the walls of the reaction devices, each segment being located in the first reaction spaces of the individual reaction devices.

This now permits processing and/or analysis in parallel and preferably automated, for example, of complete electrophoresis gels.

In another particularly preferred embodiment of the present invention the individual reaction devices of the reaction module are releasably interconnected to permit parting individual reaction devices or also whole segments of the reaction module, for example, by a designed frangible break location.

In accordance with the present invention in a first step in the method of processing biological materials a biological material is introduced into the first reaction space of the reaction device and the reaction device then closed off by applying a cover element and/or a concentration element. When introducing the biological material into the first reaction space the biological material is in a first state, for example, in a frozen or freeze dried state or in a polymer matrix, such as for example, a electrophoresis gel or in a density gradient such as, for example, in a glucose gradient.

After the reaction device is closed, a force is exerted on the material in the reaction space, resulting in passage of the material through the first transition zone into the second reaction space, the material thereby changing into a second state, for example, a dissolved, fluid, separated, size-reduced state and/or partly released from the polymer matrix. Further possible changes in state in the transition into the second reaction space are, for example, surface expansion, changing the charge, reactivity and/or processability of the material.

Preferably acting on the biological material in the second reaction space is a biologically, chemically and/or physically active or activatable material, the activity of the active material possibly being enhanced by the application of thermal, electrical and/or magnetic field energy, kinetic energy or the like.

In a further step in the method the biological material is transported by a force through a through-passage of the first defining element or through the transition zone back into the first reaction space, the material thereby preferably changing into a third state.

In accordance with a particularly preferred embodiment of the present invention a filtration is implemented on transition of the biological material into the first reaction space, the biologically, chemically and/or physically active or activatable material preferably being held back by the porous, filter or criss-cross structured structure arranged in the through-passage of the first defining element.

In a further step in the method, preferably in conjunction with the previous step in the method, the biological material passes by force through the free cross-section into the third reaction space. In a further step in the method, likewise in conjunction with the previous step in the method, the biological material passes through the second transition zone into the fourth reaction space it preferably thereby assuming a fourth state. It is particularly preferred on passage of the biological material through the second transition zone that at least part of the biological material is absorbed and/or adsorbed by a first absorbent and/or adsorbent, the remainder of the material preferably being absorbed and/or adsorbed within the fourth reaction space by a second absorbent and/or adsorbent.

Preferably on passage through the second transition zone amino acids, amino acid sequences, nucleotide and/or nucleotide sequences contained in the biological material are bonded by chromatographic material or column chromatographic material arranged in the second transition zone.

At least part of the absorbed or adsorbed material is dissolved by a polar or non-polar solvent, particularly an alcohol, from the first or second absorbent and/or adsorbent after opening of the reaction vessel and parting the concentration element or cover element from the underpart of the reaction device, and then made available for subsequent analysis, for example, in mass spectrographic or sequential analysis.

Preferably, force is applied to the biological material or substances within the reaction device by gravitational force, more particularly centrifugal force with an acceleration of preferably 500 G, preferably 1000 G, preferably 2000 G, preferably 5000 G, preferably 10,000 G, preferably 20,000 G or by pressure, vacuum or osmotic pressure, by a field of force, preferably an electrical and/or magnetic force field or the like.

Preferably the reaction device in accordance with the invention is arranged so that the force applied to the biological material or substances within the reaction device acts at least partly in the direction of, or contrary to, at least one preferred direction of the reaction device.

Particularly preferred when introducing a biological material into the first reaction space is a simultaneous separation of the biological material from a combination of a plurality of biological materials, preferably from an expansive matrix, more particularly from an electrophoresis gel or the like containing a plurality of biological materials.

In a particularly preferred embodiment of the present invention the reaction device comprises a vessel-type underpart comprising the first and second reaction space as well as the first transition zone. In addition, this reaction device comprises a lid or cover element. Preferably the lid is connected in one piece or by several pieces to the underpart, for example, by a hinge or a film-type articulation and comprises the third or any further reaction space. Connecting the underpart to the lid results in these reaction spaces being interconnected, where necessary, by further transition zones arranged in the underpart and/or lid (cover element).

In this arrangement it is particularly preferred that underpart and lid of the reaction device are configured so that the reaction device, when fully assembled, features an outer contour substantially symmetrical about a plane of symmetry.

Especially in the case of such a symmetrical design of lid and underpart the reaction device has at least one preferred orientation, enabling it to be inserted into means mounting the reaction devices, preferably a centrifuge or the like in at least two preferred directions of orientation, namely along or contrary to the preferred orientation, so that the effect of the gravitational force can be exerted on the reaction device or the biological materials or substances contained therein in or contrary to the preferred orientation.

The reaction device in accordance with the invention comprises at least one component (concentration element) defining at least one further, preferably third reaction space within the reaction device. Preferably the third reaction space connects the first or second reaction space via a free cross-section or transition zone.

In yet a further particularly preferred embodiment the first reaction space of the reaction device, likewise arranged within the components and as may be defined by further defining elements or webs, is connected to the third reaction space by a trough-passage. Preferably the components and more particularly the through-passage comprise a filter, a porous material, a membrane, a criss-cross structured element, a funnel-shaped element, a capillary and/or the like.

Particularly preferred components are, for example, pipette tips suitably and provided for use with lab-type, automatic or Eppendorf pipettes. In this arrangement the pipette tip can be mounted directly on the pipette after opening the reaction device in accordance with the invention, especially after removal of the underpart and thus removed from the cover element or lid of the reaction device.

Particularly preferred the concentration element or pipette tip comprises at least in its tip a filter, a porous material, a membrane, a funnel-shaped element and/or the like, it being particularly preferred that the pipette tip comprises in its tip portion an absorbent or adsorbent, more particularly a chromatographic or column chromatographic material or a material carrying free hydrocarbon compounds.

In a particularly preferred embodiment the pipette tip comprises a further defining element which protrudes into the inner portion of the pipette tip preferably symmetrical to the longitudinal centerline of the pipette tip and by which a funnel-shaped through-passage is formed which is preferably provided at least in part, with a filter, a criss-cross structured element, a molecular sieve, a porous element or an absorbent or adsorbent.

Particularly preferred the tip portion of the pipette tip or of the concentration element constitutes a second transition zone connecting the third reaction space to the fourth reaction space.

Preferably the concentration element or the pipette tip is adapted in a correspondingly shaped cover element or lid such that a substantially positive and/or non-positive connection exists between the concentration element and the lid of the reaction device which is substantially fluid-tight and where necessary, is sealed by further sealing elements in the tip portion of the pipette tip.

Particularly preferred the underpart, the lid and the component are interconnected such that the connections are simple to make and break. More particularly, in one particularly preferred embodiment the component, the underpart and the lid are positively connected to or engage each other, at least in part. Particularly preferred the underpart, lid and/or the component comprise in the assembled condition of the reaction device at least one common, interengaging and/or interjoining inner and/or outer wall.

In a particularly preferred embodiment the outer contour of the reaction device comprises in its transition zones protuberances or bulges which cooperate for example, with a retaining means of a means for mounting reaction devices or an automated manipulator such that any uncontrolled or unwanted release of the reaction device from the mounting means or manipulator is prevented.

Particularly preferred the component is inserted in the cover element or lid such that the component protrudes into the lid substantially completely so that protuberances or steps in the outer contour of the component or pipette tip cooperate with opposing steps or shoulders on the inner contour of the lid to prevent further penetration of the component or pipette tip into the lid or cover element even when a high pressure or gravitational force is applied and ensuring subsequent release of the component, especially removal of the pipette tip from the cover element.

In yet another embodiment the connection between the underpart, the lid and/or the component is fixed by a retaining means which ensures that the underpart, the lid and/or the component cannot be pulled apart uncontrolled and unwantedly even on application of high pulling forces. Particularly preferred the retaining means is configured so that it can be broken for example, at a designed frangible location by a predefined transverse or bending load or, instead, is locked in place by a locking element for facilitated opening.

Particularly preferred the first defining element is configured integrally with the wall of the underpart of the reaction device. In a further embodiment the first defining element is materially and/or non-positively connected to the wall of the underpart.

In a reaction apparatus in accordance with the present invention a plurality of reaction devices in accordance with the present invention is accommodated, the reaction apparatus communicating application of a force on the reaction devices and/or the substances or materials contained therein, more particularly a gravitational force, centrifugal force, centripetal force, a magnetic and/or electrical force, pressure or vacuum so that the substances contained in the reaction devices can be moved between the reaction spaces of the corresponding reaction devices in being transported through the transition zones between the reaction spaces.

Preferably in this arrangement, parts of the biological material(s) and/or substances are bound and/or received by correspondingly configured structures of the transition zones, such as absorbents and/or adsorbents, or their state is changed by the structures of the transition zones.

In a particularly preferred embodiment the reaction device after being charged with the biological materials in the first reaction space is inserted in a first preferred orientation into the rotor of a centrifuge and after centrifuging and, where necessary, after a predefined incubation period is inserted into the rotor of a centrifuge in a second preferred orientation, preferably in a direction inverse to an axis or plane of symmetry.

In particularly preferred further embodiments of the reaction device in accordance with the invention further components are incorporated in the reaction device such as filters, porous materials, membranes, housing sections, defining elements, parting zones, transition zones and/or the like, resulting in a further sub-division of the reaction device into further reaction spaces. In this way, whole reaction cascades are passed through by grading the nature, strength and, where necessary, also the direction of the applied force enabling even complicated reaction sequences involving several steps in the method to be implemented in a reaction device.

In this arrangement there exists between the various reaction spaces a connection which is preferably designed to permit an interaction of the substances introduced into the reaction device with the reaction device or substances or materials already present in the reaction device, resulting in cleaning, concentration, separation, processing, reaction, blending, homogenization, modification and/or some other desired change in property of the introduced substances.

In a particularly preferred embodiment of the present invention at least two outer walls of at least two reaction spaces in accordance with the invention are interconnected integrally, resulting in an arrangement (reaction module), preferably a matrix-shaped arrangement of several reaction devices.

This now makes it possible to run a plurality of steps in the reaction in a plurality of reaction devices in parallel. In such an arrangement of several reaction devices the preferred orientations of the reaction devices are preferably arranged substantially the same.

Inserting such an arrangement having at least two preferred orientations in a mount thus likewise makes it possible, the same as described in the case of individual reaction devices, to implement the reaction sequences simultaneously or staggered in time and/or space in an arrangement of reaction devices which can be designed sub-structured to any complex extent.

Further advantages and possibilities of application of the present invention will now be detailed by way of example aspects with reference to the drawings.

It is understood that the example aspects are not to be interpreted as restricting the invention in any way. Instead, the scope of the description of the example embodiments is to be viewed as disclosing also such variants, elements and combinations as resulting from a combination or modification of individual features as contained in the background description, the example embodiments, claims or drawings although these feature combinations or modifications fail to be expressly shown or described in an example aspect and where necessary, resulting in a modified subject matter or new steps in the method or a new sequence thereof.

It is further to be noted expressly that the drawings show the reaction devices and modules in accordance with the invention merely diagrammatically and thus cannot be interpreted to disclose restricting features as regards shape, size and configuration of individual elements or combinations thereof.

In the drawings:

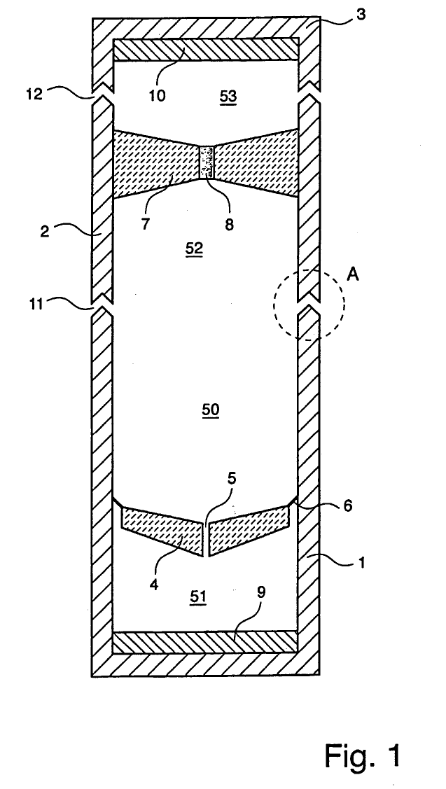

FIG. 1 is a diagrammatic illustration of a reaction device in accordance with the present invention in cross-section;

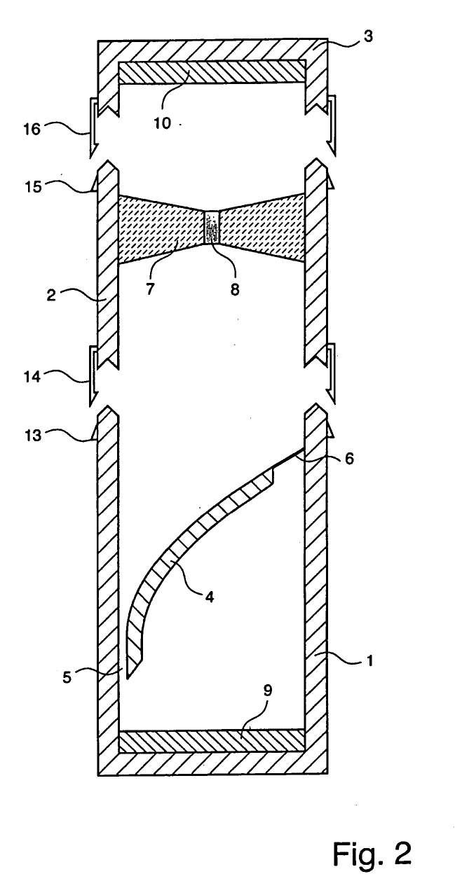

FIG. 2 is a diagrammatic illustration of an alternative embodiment of the reaction device in accordance with the present invention in cross-section;

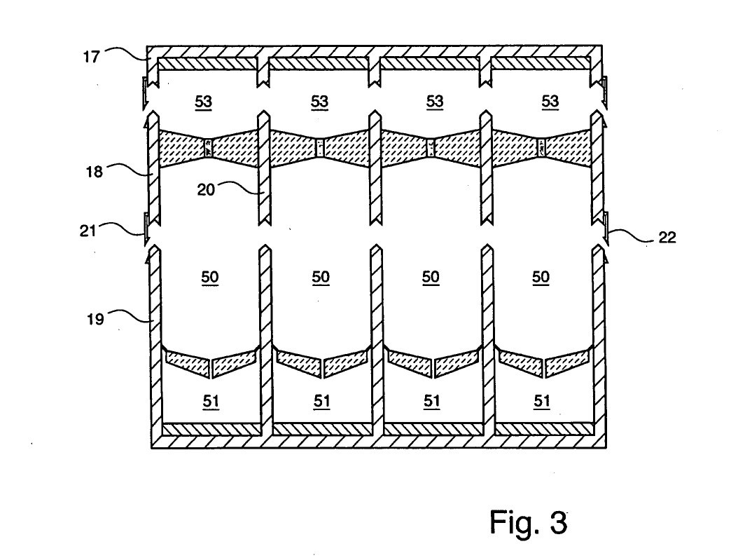

FIG. 3 is a diagrammatic illustration of a reaction module in accordance with the present invention in cross-section;

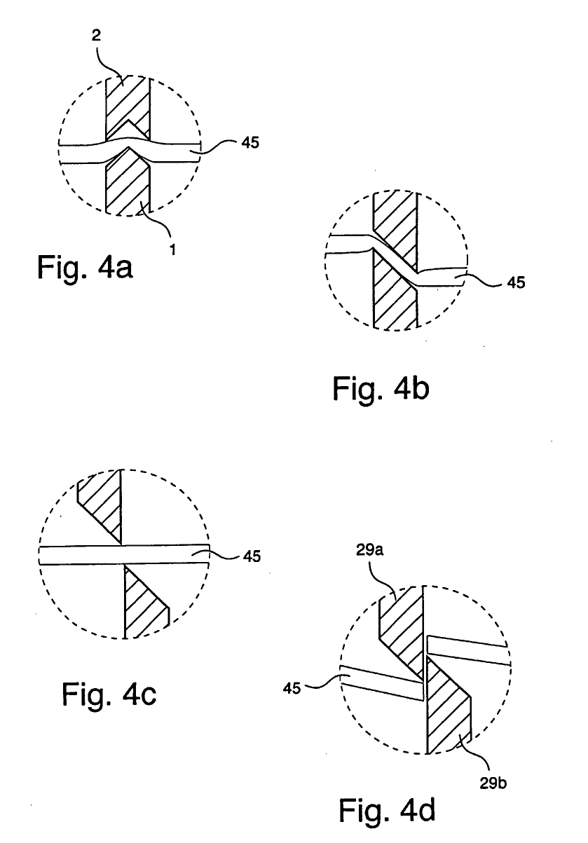

FIG. 4a is a detail view of the connecting zone A of a reaction device as shown in FIG. 1 during polymer matrix separation;

FIG. 4b is a detail view of an alternative embodiment of the connecting zone A of a reaction device as shown in FIG. 1 during polymer matrix separation;

FIG. 4c is a detail view of a further alternative embodiment of the connecting zone A of a reaction device as shown in FIG. 1 during polymer matrix separation;

FIG. 4d is a detail view of the embodiment of a connecting zone A as shown in FIG. 4c after polymer matrix separation;

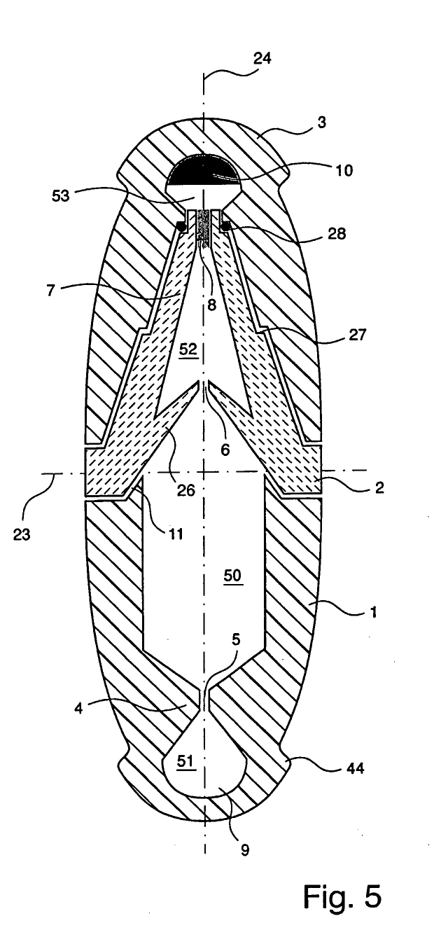

FIG. 5 is a diagrammatic illustration of a reaction device in accordance with the invention in cross-section;

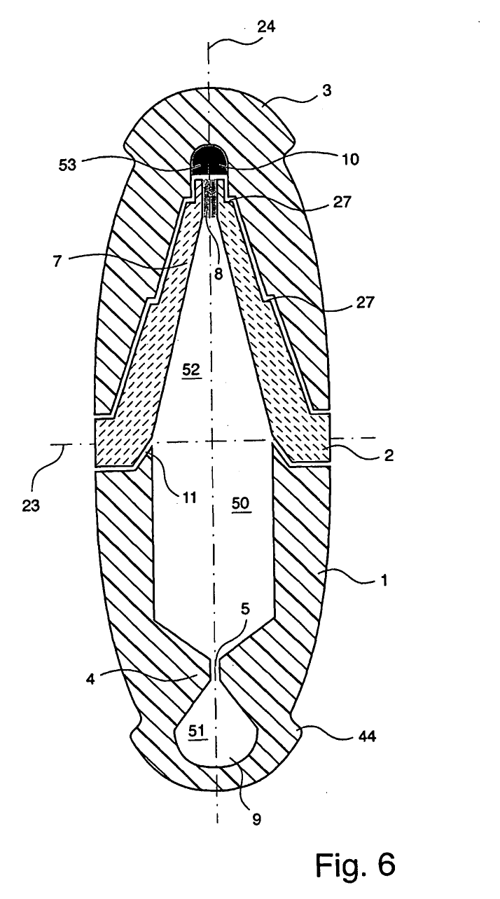

FIG. 6 is a diagrammatic illustration of a further embodiment of a reaction device in accordance with the present invention in cross-section;

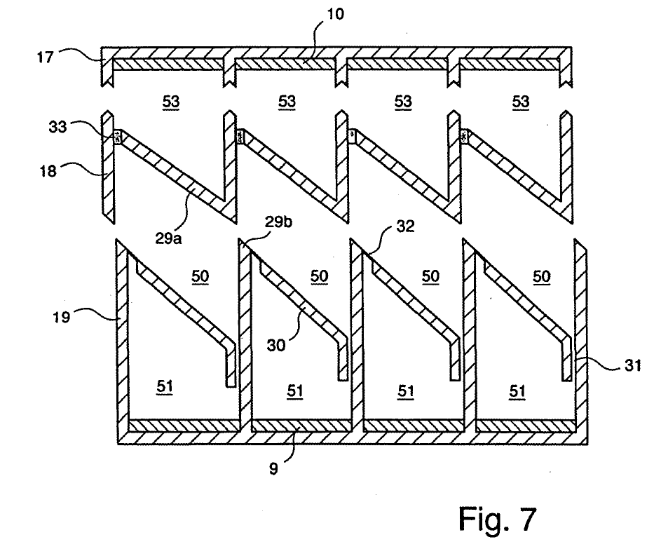

FIG. 7 is a diagrammatic illustration of an alternative embodiment of a reaction module in accordance with the present invention;

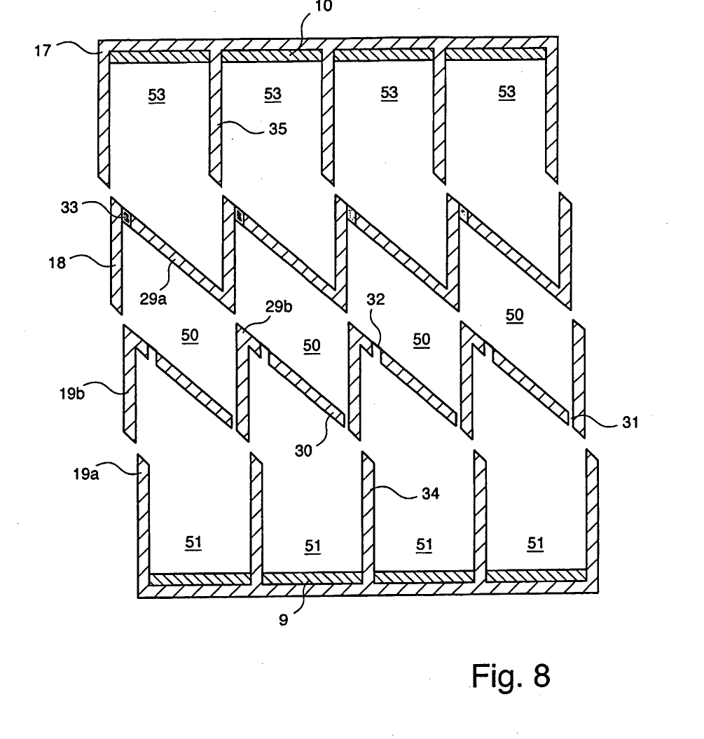

FIG. 8 is a diagrammatic illustration of a further alternative embodiment of a reaction module in accordance with the present invention;

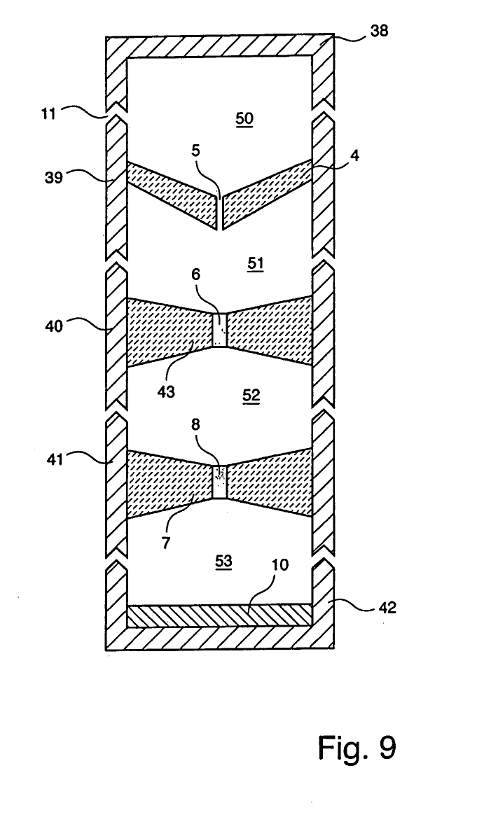

FIG. 9 is a diagrammatic illustration of an alternative embodiment of a reaction device in accordance with the invention.

Referring now to FIG. 1 there is illustrated diagrammatically a cross-section of a preferred embodiment of a reaction device in accordance with the present invention, comprising an underpart 1, a concentration element 2 and a cover element 3.

In accordance with a particularly preferred embodiment one such device comprises a substantially cylindrical basic shape, the individual elements/parts being positively interconnectable at the connecting zones 11 and 12.

In accordance with a particularly preferred embodiment the connecting zones are made via a so-called tongue-and-groove connection and can be non-positively connected by means of a connecting element (not shown).

As shown in FIG. 1 the underpart 1 of the reaction device comprises a defining element 4 which is connected to the inner sidewall of the underpart for example, by webs. In accordance with a particularly preferred example aspect the defining element 4 further comprises a transition zone 5 which as shown in FIG. 1 extends substantially parallel to the longitudinal centerline of the reaction device.

In accordance with a particularly preferred example aspect there is arranged in the space between the defining element 4 and the inner contour of the sidewall 1 a through-passage 6 comprising preferably a criss-cross structured or porous element permitting the passage at least in one direction of fluids and/or biological materials, more particularly proteins having a predefined molecular mass.

The defining element 4 defines a first reaction space 50 which as shown in FIG. 1 extends substantially above the defining element and which is connected to a second reaction space 51 through the transition zone 5.

The second reaction space comprises in accordance with a particularly preferred example aspect in the bottom zone 9 a biologically, physically and/or chemically active or activatable material able to react with a biological material introduced through the first transition zone.

In accordance with another particularly preferred example aspect there is arranged in the bottom zone of the second reaction space one or more active and/or activatable materials preferably containing proteases, nucleases or the like.

To attain optimum reaction conditions for an enzymatic reaction for example, with a biological material, use may be made in addition to active or activatable materials of further materials or enhancing the reaction conditions or the reaction speed such as for example, buffers or mediators and/or catalysts.

In accordance with yet another particularly preferred example aspect the underpart 1 is adjoined by a concentration element 2 which extends the first reaction space 50 of the underpart 1 by a further third reaction space 52 and which comprises a second defining element 7 which in accordance with a particularly preferred example aspect comprises a second transition zone 8 extending substantially parellel to the longitudinal axis of the reaction device.

In accordance with still another particularly preferred example aspect the defining elements are basically funnel-shaped, each of the transition zones being arranged at the lowest point of the funnel as viewed in the direction of flow.

The transition zone 5 thus serves in the example aspect as a flow path from the first reaction space into the second reaction space. Furthermore, the through-passage 6 as a flow path connects the second reaction space 51 to the first reaction space 50 to permit return of the biological material or its components. In addition, the first reaction space 50 is connected to the third reaction space 52 via the free cross-section and the third reaction space is connected by the second transition zone 8 to the fourth reaction space.

As shown in FIG. 1 the reaction device is closed off by the cover element 3 in defining adjoining the second defining element 7 the fourth reaction space 53 comprising a zone in which for example, an absorbent or adsorbent10 is arranged.

Particularly preferred the direction of flow is dictated by the effect of a gravitational force, particularly centrifugal force. The first and second defining elements are preferably connected to the walls of the reaction device integrally or joined to them materially for example, by an adhesive bond or inserted therein with positive connections and/or non-positive connections.

Referring now to FIG. 2 there is illustrated an alternative embodiment of a reaction device in accordance with the present invention. In accordance with this example aspect the transition zone 5 is located between the first reaction space 50 and the second reaction space 51 at a position arranged eccentrically relative to the longitudinal axis of the reaction device, i.e. as viewed in the direction of flow between the first and second reaction space at the lowest point of the first reaction space. When viewing the direction of flow from the second reaction space into the first reaction space there is provided on the right-hand side as shown in FIG. 2 a through-passage 6 which in accordance with a particularly preferred embodiment comprises a criss-cross structured or porous material or a separating element.

In accordance with a particularly preferred embodiment the transition zone 5 as shown in FIG. 2 extends over a predefined length along the inner wall of the reaction device.

Furthermore, the defining element 4 is connected to the inner wall of the reaction device in such a way that a fluid connection between the first and second reaction space occurs preferably only in the direction of flow through the transition zone 5. In this arrangement the defining element is connected to the walls of the reaction device such that even when exposed to high acceleration forces, as for instance in a centrifuge, there is no substantial change or deformation of the transition zones, particularly as regards their cross-sections.

As shown in FIG. 2, the elements of the reaction device are provided with additional locking elements 14 and 13 and 16 and 15, respectively, preventing any unwanted separation of the elements for example, during centrifuging. In accordance with a particularly preferred embodiment 14, 16 is for example, a hook clasping the protuberance 13, 15.

Referring now to FIG. 3 there is illustrated diagrammatically a reaction module in accordance with the invention in which several reaction devices are arranged in a two-dimensional matrix.

The gist of the present invention permits the number of reaction devices to be adapted especially to the particular requirements of the assaying method concerned, especially by also enabling the number of the reaction devices arranged inline (not shown) to be modified or adapted accordingly.

The reaction devices as shown in FIG. 3 comprise first reaction spaces 50, second reaction spaces 51 and fourth reaction spaces 53 each separated from the other fluid-tight by the defining walls 17, 18, and 19. In this arrangement the locking devices 21, 22 prevent accidental separation of the individual modules of the reaction module or provide positive connection and/or non-positive connection thereof.

Referring now to FIG. 4a there is illustrated a preferred embodiment of the walls of a reaction device in accordance with the invention in the region of the free cross-section, i.e. in the connecting zone A as shown in FIG. 1. In this arrangement, there is illustrated in cross-section in addition to the walls also a portion 45 of a biological material or a material (carrier) incorporating one or more biological materials, preferably a polymer matrix. Joining the walls of the underpart and concentration element of the reaction device parts the biological material or carrier material due to the separating effect of the walls as shown.

In accordance with a particularly preferred embodiment it is particularly the matrix-shaped arrangement of several reaction devices (reaction module) which serves to permit arranging a sheet sample such as e.g. a gel plate over the first reaction spaces of the lower module of a reaction module so that by mounting the middle and upper module, respectively, carrying the concentration elements or cover elements, a corresponding component part or zone of the sheet sample can be assigned to the each reaction space. In accordance with this embodiment a plurality of assaying, analytical, separation or concentration processes can be implemented, where necessary, automated and/or in parallel without having to go to the trouble of dividing up an expansive or sheet sample.

Referring now to FIGS. 4b, 4c and 4d there are illustrated alternative embodiments of the connecting zone A, indicating further possibilities of separating a sheet sample 45. In this arrangement, the sample material is parted at the edge between the walls 1, 29a and 2, 29b by joining the individual elements e.g. the concentration element and the underpart or the lower and middle module.

Referring now to FIG. 5 there is illustrated an alternative embodiment of a reaction device in accordance with the present invention. In this arrangement, the reaction device is more particularly characterized by its rotational symmetrical configuration along the axis 24 as well as by its outer contour substantially symmetrical to the axis or plane 23. In accordance with the example aspect shown in this case one such reaction device comprises three elements, the underpart 1 comprising the first reaction space 50 and the second reaction space 51. First and second reaction spaces are interconnected by the transition zone 5.

The concentration element as shown in this example aspect is configured so that it can be used as a pipette tip, i.e. for mounting on and use with lab-type, automatic or Eppendorf pipettes. This concentration element comprises a through-passage 6 which is connected by the connecting webs 26 to the base of the concentration element 2. The through-passage 6 ports into the third reaction space 52 which in turn is connected by the transition zone 8 to the fourth reaction space 53.

In accordance with a particularly preferred embodiment the through-passage 6 and the transition zone 8 comprise at least portionwise materials permitting separation, filtration, absorption, adsorption or retainment of predefined materials, more particularly materials or blends of substances by virtue of their molecular structure or mass, their charge or charge distribution or the like.

The fourth reaction space 53 in accordance with the present example aspect is arranged in the cover element 3 of the reaction device. Preferably the second defining elements 7 are the walls of the pipette tip.

To ensure a fluid-tight connection between the concentration element, i.e. the pipette tip and cover element 3, a sealing element 28 is disposed in the proximate zone of the pipette tip between pipette tip and cover element in the example aspect as shown in this case. In this arrangement the pipette tip is preferably held positively and/or non-positively connected within the cover element.

In accordance with a particularly preferred example aspect the inner contour of the walls of the cover element is adapted to the outer contour of the pipette tip or of the concentration element, particularly to accommodate forces acting, for example, on the elements and more particularly also on the pipette tip during centrifuging and communicate them to the cover element or rotor of the centrifuge. It is particularly preferred that the outer contours of the concentration element 2 or of the pipette tip are configured so that they are positively connected to the inner contour of the cover element 3 and more particularly the step 27 of the pipette tip is in contact with the opposing protuberance from the inner contour of the cover element.

Referring now to FIG. 5 there is illustrated how the underpart 1 and/or the cover element of the reaction device comprise protuberances 44 on its outer contour for cooperating, for example, with a fastener mechanism in a mount for the reaction devices, preferably a rotor of a centrifuge or a robot manipulator, to prevent the reaction device from dropping out or releasing from the mount.

The first defining elements of the reaction device as shown in FIG. 5 are preferably configured integral with the walls of the underpart or non-positively and/or materially connected thereto.

It is further to be noted that the reaction device, particularly the size of the reaction spaces, is adapted to the volume of the biological material to be assayed in each case.

Referring now to FIG. 6 there is illustrated an alternative embodiment of a symmetrical reaction device comprising three elements. Arranged in the underpart 1 are the first reaction space 50, the first transition zone 5 and the second reaction space 51. In at least a portion of the second reaction space 51 is arranged an active and/or activatable material, preferably a material containing enzymes for interaction with the biological material once having been transported into the second reaction space.

In accordance with the example aspect as shown in this case the first reaction space 50 changes in the region of the symmetrical plane or axis 23 via a free cross-section into the third reaction space 52. This third reaction space 52 is substantially formed by the inner portion of a pipette tip which in turn is accommodated substantially in the cover element 3 of the reaction device.

In the tip portion of the pipette tip in accordance with this embodiment a second transition zone is provided in which in accordance with a particularly preferred embodiment at least in a portion a material is arranged which absorbs or adsorbs at least one component of the biological material by corresponding absorption and adsorption respectively. The third reaction space 52 ports into the fourth reaction space 53 via the transition zone 8.

In accordance with a preferred embodiment the cover element 3 is mainly adapted by its inner contour to the outer contour of the concentration element, i.e. to the pipette tip. In this arrangement the shoulders 27 preferably contact protuberances from the inner contour of the cover element and, depending on the forces anticipated to act on the elements, the contact surface between the elements is defined.

Referring now to FIG. 7 there is illustrated an alternative embodiment of a reaction module in accordance with the present invention. In this arrangement it is particularly the middle module 18 and the lower module 14 that are configured so that, when assembled, the walls 29a, 29b of the modules interengage staggered to achieve separation of a sheet or matrix-shaped sample by the webs or walls 29a, 29b as described with reference to FIGS. 4c and 4d.

In accordance with the embodiment as shown in this case the reaction modules comprise first reaction spaces 50, second reaction spaces 51 and fourth reaction spaces 53. In the closed or assembled state of the reaction module the reaction spaces are interconnected by the transition zones 31, 33 and the through-passage 32. These transition zones and the through-passage comprise at least in a portion a criss-cross structured or porous element and/or an absorbent or adsorbent.

Arranged in the underparts 19 or cover elements 7 in accordance with the embodiment as shown in this case preferably in a portion of the second or fourth reaction space is an active or activatable material 9 or absorbent 10.

Referring now to FIG. 8 there is illustrated a further embodiment of a reaction module in which the module 19 comprising the underparts of the individual reaction devices is configured two-part. In this arrangement the lower part element 19a comprises the second reaction spaces 51 for insertion of a biologically, physically and/or chemically active and/or activatable material at least portionwise. The reaction spaces 51 are configured open to the environment, the upper part element 19b comprising or defining the first reaction space 50, the transition zone 31 and the through-passage 32 being configured so that the walls 30 of the upper part element 19b can be brought into engagement with the walls 34 of the lower part element 19a, more particularly the upper part element 19b can be inserted into the lower part element 19a so that the two part elements interengage at least in part, with positive or non-positive connection to produce a substantially fluid-tight connection between them. In the same way, the concentration module 18 can be inserted into the upper part element 19b and the covering module 17 into the concentration element.

In accordance with the example aspect as shown in this case, the walls of the lower and upper part element as well as those of the concentration module and the cover module are configured so that a sheet of sample material is segmented in the connecting zones between the individual elements or modules as described with reference to FIGS. 4c and 4d.

Referring now to FIG. 9 there is illustrated an embodiment of a multi-stage reaction device in accordance with the present invention. In this arrangement three intermediate elements 39, 40 and 41 are arranged between the underpart 42 and cover element 38.

Formed in this embodiment between the cover elements and the first intermediate element 39 is the first reaction space, the transition zone 5 being defined by the defining element 4 and porting into the second reaction space 51 formed between the first and second intermediate elements 40. The second reaction space is defined by the second intermediate element which comprises a through-passage 6 defined by a third defining element 43 and which ports into the third reaction space 52 disposed between the second and third intermediate elements 41. The third reaction space is connected by the second transition zone 8, defined by the second defining element 7, to the fourth reaction space, the second transition zone being arranged in the third intermediate element. Preferably arranged in the fourth reaction space at least portionwise is an absorbent and/or adsorbent 10.

In accordance with one possible assaying sequence the biological material to be processed is introduced into the first reaction space 50 and the reaction device closed, whereby any number of intermediate elements can be inserted between the underpart 42 and the cover element 38.

By applying a force, particularly pressure, vacuum or a gravitational force, the material to be processed is transported through the transition zone 5 into the second reaction space 51 in thereby experiencing a change in state, where necessary.

Preferably, the shape of the transition zone 5 is selected such that, for example, a polymer or gel matrix is destroyed at least in part.

The material introduced into the second reaction space 51 is transported in turn by application of a force which differs from the aforementioned force by nature and intensity, through the through-passage 6 into the third reaction space 52, following a predefined incubation period, where necessary. It is thus particularly preferred to arrange within the through-passage 6 at least in part, a porous, criss-cross structured, absorbent or adsorbent material for filtering, parting, separating, absorbing and/or adsorbing at least part of the material in passing through the transition zone. By further corresponding analogous steps in the method the material is transported as far as into the fourth reaction space where it is absorbed or adsorbed at least in part, by the absorbent and/or adsorbent. The materials emerging from the porous, criss-cross structured, absorbing and/or adsorbing materials can be made available for further analysis by separating the intermediate elements from each other and subsequent resuspension or dissolving by means of a polar or non-polar solvent.

Unlike the example aspect as described above, the reaction device as shown in FIG. 9 permits implementation of a plurality of reactions, more particularly separation, filtering, concentration and/or adsorption or absorption procedures with a plurality of biological materials or substances, simply by varying the intensity or nature of the forces applied, without changing the direction in which they act.

The example aspects as described make it clear that depending on the desired direction of flow the reaction device or the substances contained therein can be exposed to a force acting in various directions as achievable, for example, by differing the orientation in which they are introduced into the rotor of a centrifuge.

1-67. (canceled)

68. A reaction device for processing biological materials, particularly for processing material containing polypeptides and/or polynucleotides, the reaction device comprising:
at least one first reaction space (50) serving to receive the biological material in a first state; and,
at least one second reaction space (51) serving to receive the biological material in a second state,
wherein the first reaction space is connected to the second reaction space by at least one first transition zone (5),
the first transition zone comprising a narrowing cross-section defined by at least one defining element (4) oriented inclined, at least in part, relative to a longitudinal centerline of the reaction device, and
the first transition zone being configured so that transporting the biological material through the first transition zone results in a change of state of the biological material.

69. The reaction device as set forth in claim 68, wherein at least one defining element of the first transition zone is, at least in part, a wall (1) of the reaction device.

70. The reaction device as set forth in claim 68, wherein the minimum cross-section of the first transition zone is selected from a group of cross sections containing a cross section smaller than 1 μm, a cross section smaller than 5 μm, a cross section smaller than 10 μm, a cross section smaller than 20 μm, a cross section smaller than 50 μm, a cross section smaller than 100 μm, a cross section smaller than 200 μm, a cross section smaller than 500 μm, a cross section smaller than 1 mm.

71. The reaction device as set forth in claim 68, wherein the defining element comprises at least one through-passage, the through-passage of the defining element preferably being covered by at least one criss-cross structured element (6) and/or at least one element comprising porous through-passages.

72. The reaction device as set forth in claim 68, wherin in at least a portion of the second reaction space at least one physically and/or biochemically active or activatable material (9) is provided, the active or activatable material being particularly enzymatically active and preferably containing proteases, nucleases and/or the like.

73. The reaction device as set forth in claim 72, wherein the physical or biochemical activity of the active material is reduced and its activity being enhanced by an exogenic influence on the active material.

74. The reaction device as set forth in claim 68, wherein the cross-section of the reaction device is, at least in part, selected from a group of cross-sections containing circular cross-sections, elliptical cross-sections, polygonal cross-sections, rectangular cross-sections, square cross-sections, trigonal cross-sections, pentagonal cross-sections and hexagonal cross-sections.

75. The reaction device as set forth in claim 68, wherein the first reaction space of the reaction device is connected by at least one free cross-section to a third reaction space (52), the free cross-section preferably being defined by the walls of the reaction device.

76. The reaction device as set forth in claim 75, wherein the defining walls (1) of the free cross-section of the reaction device are bevelled, at least in part, to at least one side.

77. The reaction device as set forth in claim 75, wherein releasably connected to the reaction device is a cover element (3) covering the free cross-section of the first reaction space, the cover element comprising, at least in part, a cross-section substantially corresponding to the cross-section of the reaction device

78. The reaction device as set forth in claim 77, wherein the cover element comprises walls substantially positively connected to the defining walls in the region of the free cross-section of the reaction device.

79. The reaction device as set forth in claim 77, wherein an absorbent and/or adsorbent (10) is provided in at least a portion of the cover element or the cover element is, at least in part, an absorbent and/or adsorbent.

80. The reaction device as set forth in claim 77, wherein the releasable connection of the cover element to the reaction device is maintained by a locking element.

81. The reaction device as set forth in claim 77, wherein at least one further reaction space is disposed in the cover element.

82. The reaction device as set forth in claim 77, wherein releasably connected to the reaction device is a concentration element (2) covering the free cross-section of the first reaction space, the concentration element preferably being disposed between the first reaction space of the reaction device and the cover element and preferably comprising at least in part, a cross-section substantially corresponding to the cross-section of the reaction device and/or to the cross-section of the cover element, the concentration element comprising at least one second transition zone featuring at least one narrowing cross-section, the second transition zone being defined by at least one second defining element (7) oriented, at least in part, inclined to the longitudinal centerline of the reaction device.

83. The reaction device as set forth in claim 82, wherein the concentration element comprises walls substantially positively connected to the defining walls of the free cross-section of the reaction device and/or substantially positively connected to the walls of the cover element.

84. The reaction device as set forth in claim 82, wherein a fourth reaction space (53) is disposed between the concentration element and the cover element.

85. The reaction device as set forth in claim 82, wherein a second absorbent and/or adsorbent (8) is arranged in at least a portion of the second transition zone, the second absorbent and/or adsorbent preferably being selected from a group containing fleece, cellulose, superabsorbers, carbon compounds, hydrocarbon compounds, column chromatographic adsorbents, porous materials, minerals, salts and the like.

86. The reaction device as set forth in claim 68, wherein the outer contour of the reaction device is configured symmetrical to an axis (24), a plane (23) and/or a point of symmetry at least in part, preferably configured substantially symmetrical.

87. The reaction device as set forth in claim 77, wherein the outer contour of the reaction device and/or the cover element is configured symmetrical to an axis (24), a plane (23) and/or a point of symmetry at least in part, preferably configured substantially symmetrical.

88. The reaction device as set forth in claim 82, wherein the outer contour of the reaction device, the cover element and/or the concentration element is configured symmetrical to an axis (24), a plane (23) and/or a point of symmetry at least in part, preferably configured substantially symmetrical.

89. A reaction module for processing several biological materials, more particularly for processing multiple materials containing polypeptides and/or polynucleotides, wherein the reaction module comprises at least two interconnected reaction devices as set forth in claim 68, the connection of the reaction devices preferably being releasable.

90. A reaction apparatus, wherein the reaction apparatus comprises at least one reaction device as set forth in claim 68, the reaction device being mounted preferably in the reaction apparatus and a force being exerted by the reaction apparatus on the reaction device and/or on the substances contained therein and preferably a gravitational force, centrifugal, centripetal, magnetic and/or electrical force being exerted on the reaction device and/or on the substances contained therein.

91. A method for processing multiple biological materials, more particularly for processing multiple materials containing polypeptides and/or polynucleotides, more particularly by means of a reaction device as set forth in claim 68, wherein:
a) a biological material in a first state is introduced into a first reaction space (50);
b) the biological material in the first state is transported by the effect of a force through the first transition zone into the second reaction space (51) and is thereby changed into a second state, the change in state involving separation, size reduction or surface expansion, changing the molecular mass, charge, reactivity and/or processability of the material.

92. The method as set forth in claim 91, wherein in the second reaction space an active material (9) acts on the biological material in the second state.

93. The method as set forth in claim 91, wherein the biological material in the second state is transported by the effect of a force through the through-passage of the defining element into the first reaction space in thereby changing into a third state.

94. The method as set forth in claim 93, wherein:
the biological material in the third state is transported by the effect of a force through the second transition zone into the fourth reaction space (53) in thereby changing into a fourth state,
whereby on passage of the biological material through the second transition zone at least part of the biological material is absorbed and/or adsorbed by a first absorbent and/or adsorbent (8)
and/or at least part of the biological material obtained in the fourth state is absorbed and/or adsorbed by a second absorbent and/or adsorbent (10) in a fourth reaction space.

95. The method as set forth in claim 94, wherein at least part of the biological material absorbed and/or adsorbed by the first and/or second absorbent and/or adsorbent is dissolved, the dissolving of the biological material from the first and/or second absorbent and/or adsorbent is preferably done by a solvent.

96. The method as set forth in claim 91, wherein the force is applied by gravitational force, more particularly centrifugal force, pressure, vacuum, osmotic pressure, a force field, preferably an electrical and/or magnetic force field and/or the like.

97. The method as set forth in claim 93, wherein the force is applied by gravitational force, more particularly centrifugal force, pressure, vacuum, osmotic pressure, a force field, preferably an electrical and/or magnetic force field and/or the like.

98. The method as set forth in claim 94, wherein the force is applied by gravitational force, more particularly centrifugal force, pressure, vacuum, osmotic pressure, a force field, preferably an electrical and/or magnetic force field and/or the like.

99. The method as set forth in claim 91, wherein simultaneously with introducing the biological material in the first state into the first reaction space the biological material is separated in the first state from a combination of many biological materials, preferably as simultaneous separation of the biological material in the first state from and/or out of an expansive matrix containing a plurality of biological materials.
